(19) United States
(12) Patent Application Publication
(10) Pub. No.: US 2018/0178314 A1
(43) Pub. Date: Jun. 28, 2018

(54) 3D PRINTING APPARATUS AND A CORRESPONDING 3D METAL PRINTING METHOD

(71) Applicant: MCOR Technologies Limited, Dunleer (IE)

(72) Inventors: Fintan MACCORMACK, Ardee (IE); Conor MACCORMACK, Ardee (IE)

(21) Appl. No.: 15/737,730

(22) PCT Filed: Jun. 16, 2016
(86) PCT No.: PCT/EP2016/063953

§ 371 Date: Dec. 18, 2017

(30) Foreign Application Priority Data
Jun. 18, 2015 (EP) 1510740.2

(51) Int. Cl. B23K 20/10; B33Y 10/00; B33Y 30/00

(52) U.S. Cl. CPC B23K 20/10; B33Y 80/00; B33Y 30/00; B33Y 10/00

(57) ABSTRACT

According to the present specification there is provided a printing apparatus (100) for 3-D printing an object, the apparatus comprising a build module (200), having a build platform (300) and a print module (240). The print module comprises an input opening (210) for receiving a medium (110) and an output opening (220) through which the medium is applied to the object (500) being made on the build platform (300). The medium comprises a metal material, the metal material being provided in bead or wire form. The print module further comprises an application head (240) operable to directly join the medium to the build object, wherein the application head comprises an ultrasonic head operable to weld the medium to the build object.

### FIELD

The present application relates to 3D Metal printing and a corresponding 3D printing method.

### BACKGROUND OF THE INVENTION

Rapid prototyping is defined as computer-controlled additive fabrication, in that an object can be fabricated by the addition of material rather than conventional machining methods that rely on removal or the subtraction of material. The term “rapid” is, it will be appreciated, a relative term but one that has specific meaning within the art, in that construction of a finished three dimensional articles can take from several hours to several days, depending on the method used and the size and complexity of the model. There are known methodologies that are employed within the general field of rapid prototyping for example Layered Object Manufacture (LOM) is one form of Rapid prototyping (RP) which relates to the successive layering of adhesive-coated paper, plastic, or metal laminates which are then successively glued together and cut to shape with a knife or laser cutter.

There is an interest in providing improved 3D printed objects, method and systems.

However, there are problems with 3D printing in particular relating to use of metal materials for printing. In one approach a low melting point metal may be applied by spraying to a sedimentation build. In another approach a particulate material may be used. However, there are problems associated with 3D printing using metal including that the process is often multi-stage and requires heating systems or chemical systems rendering the technology relatively complex and having requirements for highly skilled users and management rather than being suitable for use by a non-specialist end user. The systems and materials are also often relatively expensive.

There is a need for an improved printer for printing metal 3D objects. There is a need for a printer for printing 3D objects using a metal material that addresses the above noted and other problems.

### SUMMARY

According to a first aspect the present specification provides in accordance with claim 1 a printing apparatus for 3-D printing an object comprising:
a build module for receiving a medium and controllably feeding the medium to an application head;
the medium comprising a metal bead or wire;
the application head operable to join the metal bead to the build object;
the application head comprising a heat application head operable to apply localised heat to the medium to directly bond the metal bead to the build object.

Advantageously, the apparatus and method of the specification provide for the directly joining or welding of the metal bead to the build object. The arrangement differs from previous approaches, in that the metal bead is pre-formed for application to the object. For example, the metal beam is not extruded or melted or deformed at the application head instead the metal wire is applied directly to the build object by bonding or joining.

In one arrangement the application head comprises an ultrasonic head operable to directly weld the metal bead to the build object.

In one arrangement the application head comprises a welding head operable to directly weld the metal bead to the build object.

Further, the application head may comprise force application means for applying a force to medium or the object. A force may be applied simultaneously with the application of heat. The force may be applied after the medium is heated. The force is applied locally to the medium to assist in joining the medium to the object.

In one arrangement the medium is a preformed medium, comprising a bead or wire preformed in accordance with requirements of the object to be made.

Advantageously, the apparatus and method provide for the direct application of the medium to the object. The form of the medium is not changed or affected for example by extrusion.

Advantageously the apparatus is configured for operation with a preformed medium selected taking account of the requirements of the object being built.

In another arrangement the print module configured to receive the preformed medium.

In one arrangement, the application head is configured to directly join the preformed medium to the object being made on the build platform.

In another arrangement the apparatus is configured to manufacture the 3D object by deposition modelling.

In one arrangement the medium comprises a metal bead or wire preformed having diameter and form selected in accordance with requirements for the object being made.

According to a further aspect there is provided a method for printing a 3D object:
providing 3D printing apparatus 100 having a printing module 200 and build module 300 and controller as claimed in any preceding claim
providing a medium, the medium comprising a metal wire
providing digital print file (DPF) representative of the object to be printed to printing apparatus,
operating application head to directly join or weld the bead to an object O being made.

In one arrangement the medium comprises a bead or wire preformed for application to the object, wherein the bead or wire is preformed taking account of characteristics of the object to be formed.

In one arrangement the bead or wire is pre-formed for application to the object. Advantageously, the wire does not required extensive manipulation or change of form for attaching to the object. The form of the wire used is selected on the basis of the requirements and form of the object.

In one arrangement the application head is configured to directly join the printed medium as provided to the printhead to the object.

According to another aspect there is provided a printing apparatus for 3-D printing an object comprising:
a build module, having a build platform
a print module comprising:
   an input opening for receiving a medium, and an output opening through which the medium is applied to the object being made on the build platform.
   an application head operable to directly join the medium to the build object.

According to another aspect there is provided a printing apparatus for 3-D printing an object comprising:
a build module, having a build platform
a print module comprising:
   an input opening for receiving a medium, and an output opening through which the medium is applied to the object being made on the build platform;
   wherein the medium comprises a metal material, the metal material being provided in bead or wire form;
      an application head operable to directly join the medium to the build object.

Referring to the above noted printing apparatuses, the application head may comprise a heat application head operable to apply head locally to the medium to join the medium to the build object. The application head may comprise a welding head operable to weld the medium to the build object. The application head may comprise an ultrasonic transducer application head operable to weld the medium to the build object.

The application head 240 of the various above noted printing apparatuses may be further configured to apply a force F to the medium. The application head 240 may further comprise force application means to apply a force F to the medium. The force may be applied simultaneously with heating the medium. The Force may be applied after the medium is heated. The force may be applied to the medium as it is joined to the object.

The apparatus further comprising a controller 400 wherein the controller controls the force application means.

The force may be applied continuously during the joining of the medium to the object. The force may be applied at intervals during the process of 3D printing an object.

According to a further aspect the present specification provides a 3D printed object, the object comprising a plurality of layers of a metal material applied successively to the object at the build location.

The layers of the object are derived from a metal wire or bead joined to the object on a layer by layer basis to define the object. The metal wire or bead may be pre-formed taking account of the properties of the object such that extrusion is not required. The object may be manufactured in a continuous process. The object comprises a plurality of layers joined to the object on a layer by layer basis, based on digital print file (DPF) representative of the object to be printed including layer by layer information.

### BRIEF DESCRIPTION OF THE DRAWINGS

The present application will now be described with reference to the accompanying drawings in which:

FIG. 1 is a block diagram of a printing apparatus according to an embodiment of the present teaching;

FIG. 2 is a front elevation view of an application head of a 3D printing apparatus according to an embodiment of the present specification;

FIG. 3 is a isometric view of an application head of a 3D printing apparatus according to an embodiment of the present specification;

FIGS. 4 and 5 are enlarged front elevation and isometric views of an application head of a 3D printing apparatus according to an embodiment of the present specification;

### DETAILED DESCRIPTION OF THE DRAWINGS

The present specification provides a 3D printing apparatus that provides full colour 3D printing.

In particular, the apparatus 100 relates to manufacture the 3D object by deposition modelling.

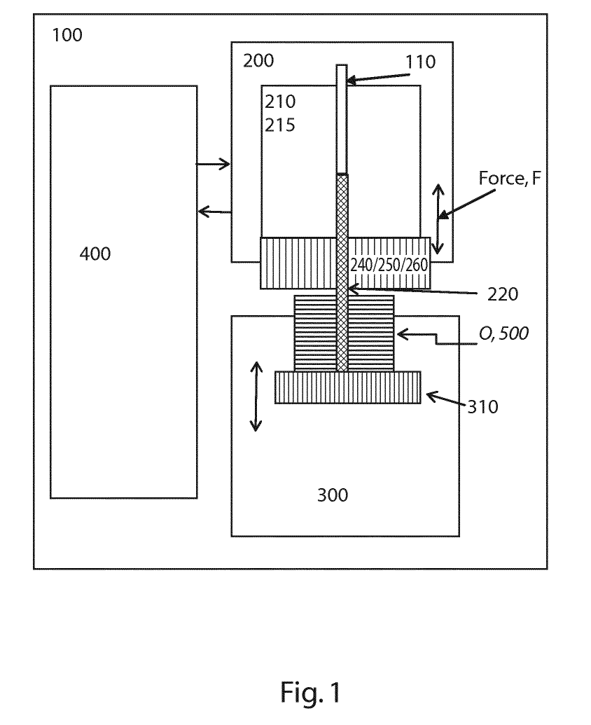

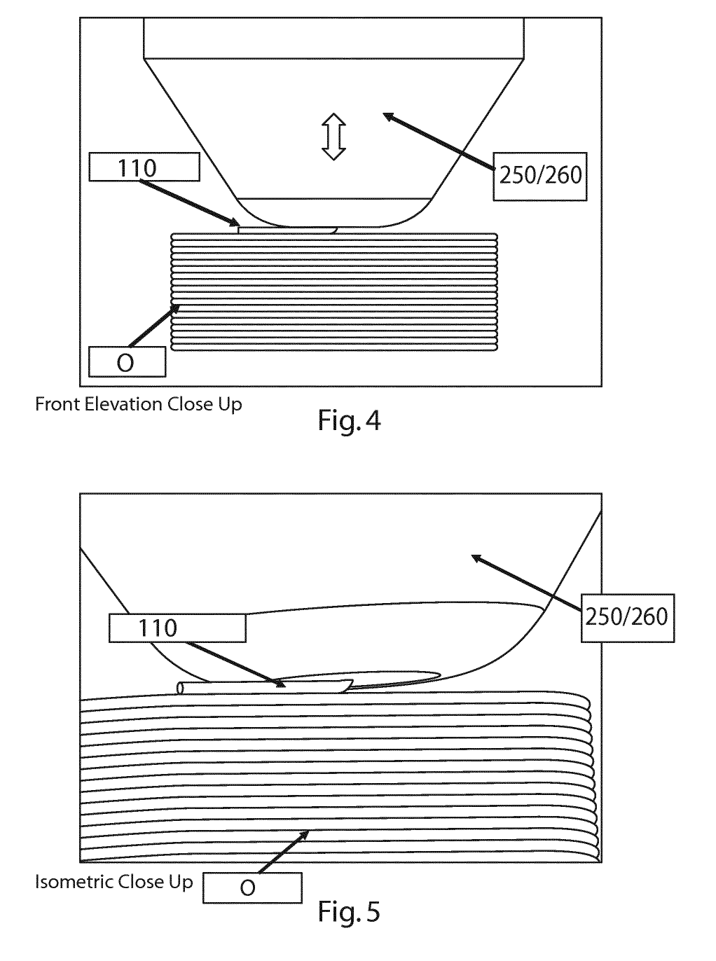

FIG. 1 is a block diagram of a 3D printing apparatus 100 according to the present specification. Referring to FIGS. 1 and 2-5, the 3D printing apparatus 100 comprises a build module 200. 3D printing apparatus 100 further comprises controller 400. The build module 200 comprises an input opening 210 for receiving medium 110 and an output opening 220. The medium 110 may comprise a metal material. The medium may be a metal bead or metal wire. The build module 200 comprises a build plate 310 on which a build object O or part 500 is built. The build module and build plate are arranged such that relative movement may be provided between the application head and build object to allow for the manufacture of an object. In an exemplary arrangement, as shown in FIG. 1 the build plate 310 is mounted to move up or down within the apparatus 100 relative to the build module and/application head as an object is built. The application head 240 is mounted to move relative to the build plate 210 and the medium 110 is applied via the output opening 220 of the build module 200 to the object O (500) being built. It will be appreciated that alternative arrangements may be provided to allow the relative movement between the components, as required.

The medium 110 may comprise a bead B or wire W of a metal material. It will be appreciated that different suitable media may be selected for building the 3D object O, based on requirements. The material, form, and dimensions of the media may be selected taking account of the properties of the object to be built. The medium is pre-formed for application to the object. This is in contrast to arrangements of the prior art which often provide for extrusion of a larger diameter bead or wire for application to the object. The input and output of the print module may be adjustable to allow the feeding and handling of various forms of preformed media.

It will be appreciated that a bead B or wire W of different suitable form may be used. For example, in one arrangement, taking account of the application and object to be formed, a bead may be selected having diameter of the order of 0.1 mm. For example, in another arrangement, per object requirements, a bead may be selected having a diameter of the order of 0.5 mm. It will be appreciated that the system may be used with beads or wires of different suitable diameter.

The medium 110 may be provided as a bead or wire, however, it will be appreciated that alternatives may be provided.

The build module 200 comprises an application head 240 for welding or joining or applying or bonding the medium 110 outputted therefrom to the object O being made. The application or welding head provides for the joining of the bead to the object. The preformed medium is joined or bonded directly to the object. In contrast to prior art FDM approaches there is no extrusion. The form of the medium is not modified or changed.

The terms welding, bonding, joining and applying have been used essentially interchangeably to refer to the process by which a preformed bead, having form and dimensions selected based on the particular application and object requirements, is joined to the object being built to manufacture the object. It will be appreciated that the joining/applying is different from extrusion processes which might involve the extrusion of a relatively larger diameter bead for the purpose of application to the object. In the case of the present specification, the medium is pre-formed for application to the object, there is no extrusion to change the form of the medium for joining it to the object.

The application head 240 may in an exemplary arrangement be an ultrasonic transducer head. In another exemplary arrangement, the application head may be a welding head. In another exemplary arrangement, the application head may be a heating head, not an ultrasonic or welding head, which provides localised heating to raise the temperature of the medium at the point of application to the build object, as required, to provide a bonding or joining of the medium to the build object. In the exemplary arrangements, the medium is not extruded. The preformed medium selected for the particular object, is directly joined, or bonded or applied by the application head to the object.

The medium may be applied to the build object in a continuous method.

The application head 240 further comprises force application means 260 for applying a force F to the medium. A force may be applied simultaneously with heating the medium. Force may be applied after the medium is heated. The force may assist in joining the medium to the object. The controller 400 provides control of the force application means. Force may be applied continuously during the joining of the medium to the object. Force may be applied at intervals during the process of 3D printing an object. For example, force may be applied while a layer of the medium is formed by heating the medium to join it to the object. After a layer is joined to the object and before the joining of the next layer begins, the application head may be driven to apply force to the most recently applied layer.

The force may be controllable to assist in locating the metal for joining to the object. Further, in contrast to an extrusion system, the force may be controllable so as not to deform or reshape the metal as in the case of an extrusion system.

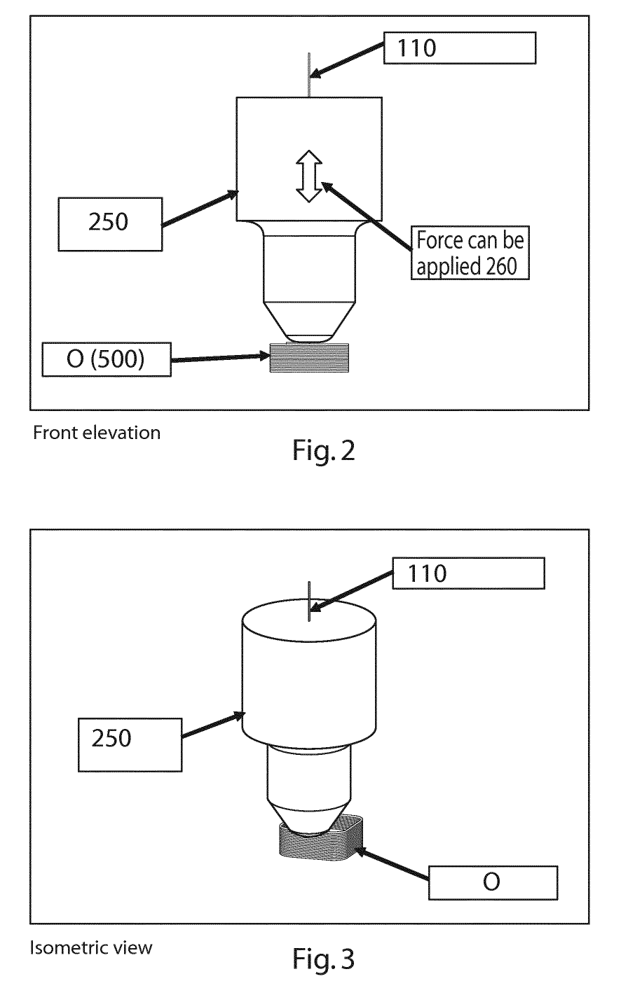

In the exemplary arrangement of FIG. 2 the build module 200 comprises, the application head comprises an ultrasonic transducer head 250 for welding the medium for example the metal bead or wire to the object O being made. In a preferred exemplary arrangement a preformed bead 110 of form and diameter selected for application to form a particular object is provided. The use of ultrasonic head 250 together with the preformed bead or wire of selected diameter in conjunction provides an overall advantageous arrangement for 3D metal printing of an object.

The apparatus 100 provides an alternative approach to metal 3D printing. Using the apparatus 100, a bead comprising a metal material may be welded or joined to the object without affecting the overall form or integrity in the way that approaches of the prior art which included extrusion or mixing of wires or blending or mixing.

In the exemplary arrangement of FIG. 2, the build module 200 comprises a chamber 215 and the metal bead passes in through the input opening 210 through chamber 215 and towards the outlet opening 220. In the exemplary arrangement, the bead is fed in a vertical orientation through the chamber. It will be appreciated that various suitable arrangements.

It will be appreciated that the build module 200 may be mounted by any suitable means relative to the build plate 310 to enable relative movement of the application head 240 relative to the build plate 210, as required. For example, the printing module may be mounted on an XY frame, of type known in the field of the present specification.

According to the present specification there is further provided a method for metal 3D printing using the 3D printing apparatus 100.

An exemplary method according to the present specification includes:
providing 3D printing apparatus 100 having a printing module 200 providing medium 110

In a preferred exemplary arrangement the medium comprises a bead preformed taking account of the application of the print run. It will be appreciated that the medium may be selected depending on the final object being manufactured.
operating application head 250 to weld or join the bead to an object O being made.

The object is made in accordance with print files which define the form of the object to be printed for form. The form of the layers of the object is also defined.

Steps in an exemplary arrangement which will include pre-generating a digital print file are briefly noted herein, however, it will be appreciated that alternative methods may be provided. As is known in the art, 3D printing starts with a 3D data file, which is representative of the 3D object to be printed. For example the universal industry standard file format for 3D product designs, STL, as well as OBJ and VRML (for colour 3D printing) can be used with the present teaching, however, it will be appreciated that suitable alternatives may also be used.

The data in such files is read and the computer model is sliced into printable layers equivalent in thickness to the media layer. Such generation of the data file usually takes place at a PC or computing device connected to the printer 100 however this should not be interpreted as limiting as such processing may also take place in the printing apparatus 100. It will be appreciated that in alternative arrangements the slicing could be performed in the cloud, or on a mobile device, tablet, phone. Furthermore the present teachings are not limited to the above method of file generation and any suitable method of generating 3D print files may be used. The pre-generated file is provided or otherwise loaded to the printing apparatus 100 prior to beginning the 3D print job—although not shown, the 3D printing apparatus 100 includes a processor or controller 400 and as well as memory onto which the print file is loaded.

The digital print file is again referenced or read by the controller/processor 400. The digital print file may comprise a series of images or of image pairs 600A/600B for each media layer 701. The digital print file may comprise colour image information for the first side and the second side for all portions of the medium to be applied in layers to build the objection.

The 3D printing apparatus 100 is operable to print a 3D metal object. A bead or wire of a metal material is provided to the printing or build module 200. The bead or wire is preformed and selected based on object requirements. For example a bead or particular diameter suitable for the object to be formed may be provided. The wire is welded or joined to the object on the build plate. Controller 400 controls welding or joining of the medium to the object.

Accordingly, the arrangement of the present specification provides a number of advantages in comparison with approaches of the prior art including: provides a head to weld the metal bead to the part being made; provides for use of reduced diameter size of bead for example reduced to 0.1 mm diameter, this obviates the need for extrusion; provides a full metal 3D printer of high quality colour.

Advantageously, the apparatus and method of the present specification provide for the joining or welding of the bead directly to the object. The medium is preformed taking account of requirements of the object.

Advantageously, the apparatus and method provide for the direct printing and welding or joining of the printed medium, for example without the need for extrusion. Further, there is no requirement for milling or otherwise reforming or reshaping of the layers, as seen in prior art approaches. There is no requirement for handling a volume of molten material or for handling a powered material. There is no requirement for a mould. The apparatus and method provide essentially a direct deposition modelling. The apparatus and method provide high levels of control of the material and the output to the object.

The apparatus and method provide manufacture in a method somewhat similar to FDM, however, as described and discussed above the medium is not extruded prior to joining, welding or bonding to the object for object manufacture.

The words comprises/comprising when used in this specification are to specify the presence of stated features, integers, steps or components but does not preclude the presence or addition of one or more other features, integers, steps, components or groups thereof.

1. A printing apparatus for 3-D printing an object comprising:
a build module, having a build platform
a print module comprising:
an input opening for receiving a medium, and an output opening through which the medium is applied to the object being made on the build platform;
wherein the medium comprises a metal material, the metal material being provided in bead or wire form;
an application head operable to directly join the medium to the build object, wherein the application head comprises an ultrasonic head operable to weld the medium to the build object.

2. The printing apparatus as claimed in claim 1 wherein the application head comprises a heat application head operable to apply heat locally to the medium to join the medium to the build object.

3. The printing apparatus of claim 1, the print module further comprising an input opening for receiving a medium, and output opening through which the medium is applied to the object being made on the build platform.

4. The printing apparatus of claim 1, wherein the medium is a preformed medium, comprising a bead or wire preformed in accordance with requirements of the object to be made.

5. The printing apparatus of claim 1, the print module configured to receive the preformed medium, to directly print onto the surface of the preformed medium.

6. The printing apparatus of claim 1, the application head configured to directly join the printed preformed medium to the object being made on the build platform.

7. The printing apparatus of claim 1, wherein the apparatus is configured to manufacture the 3D object by deposition modelling in which the medium is applied directly to the object.

8. The apparatus of claim 1 wherein the medium comprises a metal bead or wire preformed having diameter and form selected in accordance with requirements for the object being made.

9. The apparatus of claim 1 further comprising a controller for
receiving and/or processing digital print file (DPF) data representative of the object to be printed, including layer by layer information, and
operating application head to directly join the printed bead to an object O being made according to the layer by layer information.

10. A method for printing a 3D object:
providing 3D printing apparatus having a printing module and build module as claimed in any preceding claim
providing medium
providing digital print file (DPF) representative of the object to be printed including layer by layer information to printing apparatus,
operating application head directly join the printed bead to an object O being made, and
wherein the medium comprises a bead or wire preformed for application to the object, wherein the bead or wire is preformed taking account of characteristics of the object to be formed.

11. A method as claimed in claim 10 wherein the bead or wire is pre-formed for application to the object such that extrusion is not required.

12. A method as claimed in claim 10 wherein the application head comprises an ultrasonic transducer is configured to directly join the medium as provided to the build module to the object.

13. (canceled)

14. A printing apparatus for 3-D printing an object comprising:
a build module, having a build platform
a print module comprising:
an input opening for receiving a medium, and an output opening through which the medium is applied to the object being made on the build platform;
wherein the medium comprises a metal material, the metal material being provided in bead or wire form;
an application head operable to directly join the medium to the build object.

15. The printing apparatus as claimed in claim 14 wherein the application head comprises a heat application head operable to apply heat locally to the medium to join the medium to the build object.

16. The printing apparatus as claimed in claim 14 wherein the application head comprises a welding head operable to weld the medium to the build object.

17. The printing apparatus as claimed in claim 14 wherein the application head comprises an ultrasonic transducer application head operable to weld the medium to the build object.

18. The printing apparatus as claimed in claim 14 the application head further configured to apply a force F to the medium.

19. The printing apparatus as claimed in claim 14 the application head further comprising force application means to apply a force F to the medium.

20. The printing apparatus of claim 18 wherein the force is applied simultaneously with heating the medium.

21. The printing apparatus of claim 18 where the Force is applied after the medium is heated.

22. The printing apparatus of claim 18 wherein the force is applied to the medium as it is joined to the object.

23. The printing apparatus of claim 18, the apparatus further comprising a controller wherein the controller controls the force application means.

24. The printing apparatus of claim 18, wherein force is applied continuously during the joining of the medium to the object.

25. The printing apparatus of claim 18 wherein force is applied at intervals during the process of 3D printing an object.

26. A 3D printed object, the object comprising a plurality of layers of a metal material applied successively to the object at the build location.

27. The object of claim 26 wherein the layers of the object are drawn from a metal wire or bead joined to the object on a layer by layer basis to define the object.

28. The object of claim 26 wherein the metal wire or bead is pre-formed taking account of the properties of the object such that extrusion is not required.

29. The object of claim 26 wherein the object is manufactured in a continuous process.

30. The object of claim 26 wherein the object comprises a plurality of layers joined to the object on a layer by layer basis, based on digital print file (DPF) representative of the object to be printed including layer by layer information.
